(19) United States
(12) Patent Application Publication
(10) Pub. No.: US 2013/0013166 A1
(43) Pub. Date: Jan. 10, 2013

(54) DETERMINATION OF EXHAUST BACK PRESSURE

(75) Inventors: Simon Petrovic, Aachen (DE); Alain Marie Roger Chevalier, Henri-Chappelle (BE); Arno Bartsch, Maastricht (NL)

(73) Assignee: Ford Global Technologies, LLC, Dearborn, MI (US)

(21) Appl. No.: 13/541,603

(22) Filed: Jul. 3, 2012

(30) Foreign Application Priority Data
Jul. 5, 2011 (EP) 11172695.6

(51) Int. Cl. F02D 28/00; G01M 15/09

(52) U.S. Cl. 701/102; 73/114.76

(57) ABSTRACT

Systems and methods for determination of exhaust back pressure in a turbocharged engine are disclosed. In one example approach, a method for determination of exhaust back pressure for an engine with a two-staged turbocharger comprises measuring a temperature downstream the engine, a temperature downstream the turbocharger, and/or a pressure downstream the turbocharger; determining a flow parameter for exhaust mass flow; estimating an overall turbine pressure ratio or a difference with a model of the turbocharger based on the measured and determined parameters; and determining the exhaust back pressure downstream the engine with the model.

### RELATED APPLICATIONS

The present application claims priority to European Patent Application No. 11172695.6, filed on Jul. 5, 2011, the entire contents of which are hereby incorporated by reference for all purposes.

### BACKGROUND AND SUMMARY

The trend of higher specific power has resulted in the requirement not only for turbocharging but for multi-stage turbocharging such as series sequential or parallel sequential configurations. The exhaust manifold pressure parameter is a fundamental property of the engine and helps to determine the exhaust gas recirculation (EGR) flow rate which is important for NOx pollutant reduction. The exhaust back pressure (EBP) is therefore important for a model based air path control. One approach is to employ a sensor to determine exhaust gas pressure.

However, the inventors herein have recognized that the harsh exhaust conditions such as soot, heat and toxic gases may adversely affect the durability of such a sensor. Further, for speed of response, a large exposure of the sensor element may be required which reduces sensor durability further. The sensor set and location may also be driven by aftertreatment requirements such as EGR cooler diagnostics or lean NOx trap (LNT) or diesel particulate filter (DPF) control.

In one example approach to at least partially address these issues, a method for determination of exhaust back pressure for an engine with a two-staged turbocharger comprises measuring a temperature downstream the engine, a temperature downstream the turbocharger, and/or a pressure downstream the turbocharger; determining a flow parameter for exhaust mass flow; estimating an overall turbine pressure ratio or a difference with a model of the turbocharger based on the measured and determined parameters; and determining the exhaust back pressure downstream the engine with the model.

Such an approach may provide an alternative for a vulnerable physical exhaust back pressure (EBP) sensor which may degrade due to harsh exhaust conditions as described above. Modeling the exhaust back pressure based on temperature readings rather than employing an EBP sensor may potentially reduce costs and increase reliability of an exhaust back pressure measurement system. Further, the flexibility of the sensor set and location associated with an exhaust back pressure measurement system may be increased so that, for example, aftertreatment devices may be accommodated. Further, exhaust flow, an important factor for the base model characterization, may be deduced from the measured parameters and can be used for a model based charge control (MCC) and/or a model based air path control, for example.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of turbocharged engine.

FIG. 2 shows a schematic diagram of a model setup in an engine in accordance with the disclosure.

FIG. 3 shows an example measurement sweep for different values of a high pressure turbine bypass valve (TBV).

FIG. 4 shows an example diagram of flow vs. overall turbine pressure ratio (PRT).

FIG. 5 shows a schematic diagram of a model for determining exhaust back pressure in accordance with the disclosure.

FIG. 6 shows an example method for determining exhaust back pressure in accordance with the disclosure.

FIG. 7 shows a diagram of exhaust back pressure.

FIG. 8 shows diagrams with the tolerances of the exhaust back pressure results estimated in accordance with the disclosure.

FIG. 9 shows diagrams for different turbine pressure ratios (PRT) and turbine pressure differences (DELTA P) vs. flow parameterisation forms in accordance with the disclosure.

### DETAILED DESCRIPTION

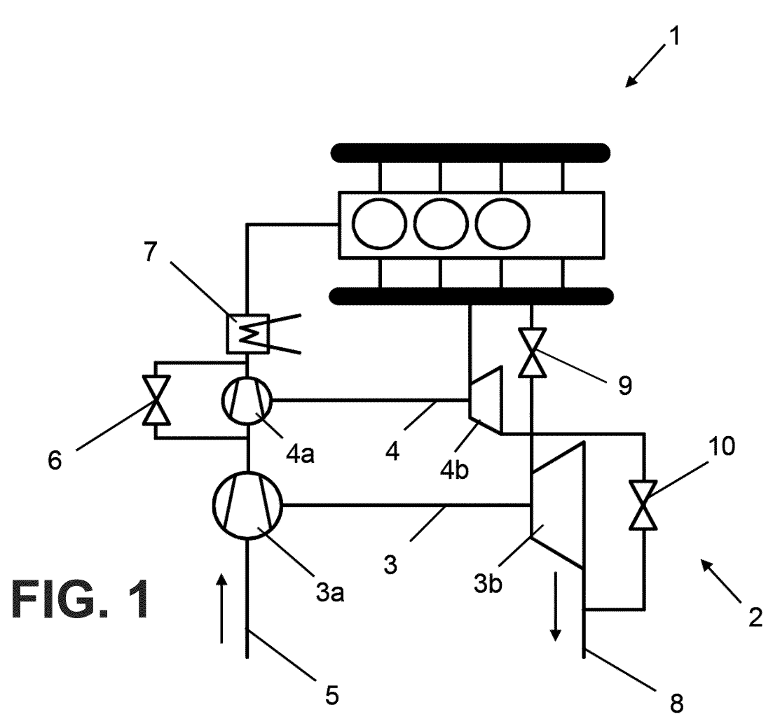

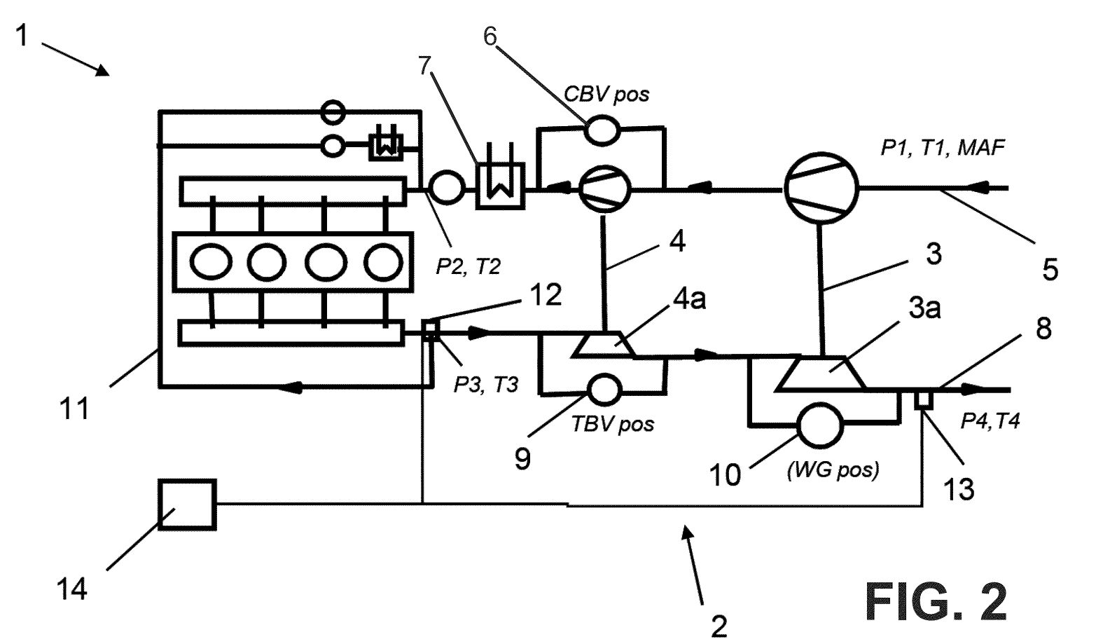

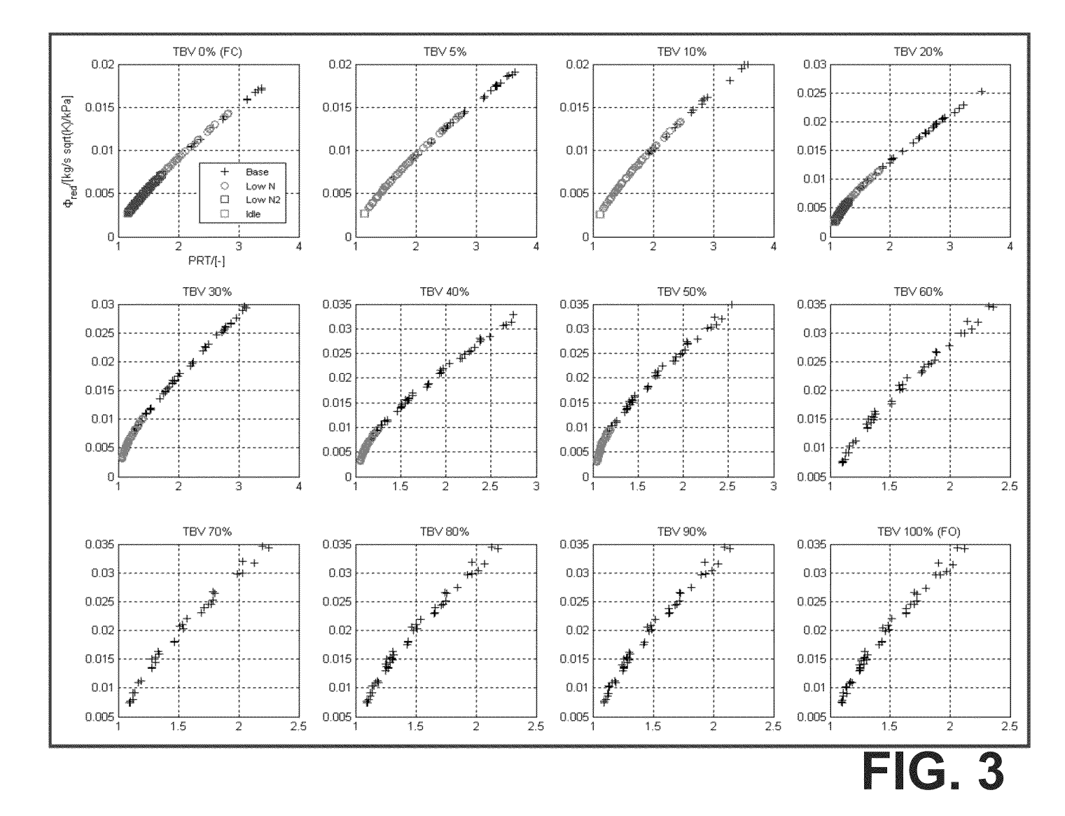

The present disclosure is directed to systems and methods for determination of exhaust back pressure in a turbocharged engine, such as the engines shown in FIGS. 1 and 2. The systems and methods described herein may provide an alternative for a vulnerable physical exhaust back pressure (EBP) sensor which may degrade due to harsh exhaust conditions as described above. Modeling the exhaust back pressure based on temperature readings, as described below with reference to FIGS. 3-6, rather than employing an EBP sensor may potentially reduce costs and increase reliability of an exhaust back pressure measurement system. Further, the flexibility of the sensor set and location associated with an exhaust back pressure measurement system may be increased so that, for example, aftertreatment devices may be accommodated. Further, exhaust flow, an important factor for the base model characterization, may be deduced from the measured parameters and can be used for a model based charge control (MCC) and/or a model based air path control, for example.

Turning to the figures, the accompanying drawings are included to provide a further understanding of embodiments. Other embodiments and many of the intended advantages will be readily appreciated as they become better understood by reference to the following detailed description. The elements of the drawings do not necessarily scale to each other. Like reference numbers designate corresponding similar parts.

FIG. 1 shows an engine 1 as a four cylinder combustion engine with a turbocharger 2. The turbocharger 2 has two stages, a low pressure (LP) stage 3 and a high pressure (HP) stage 4. It should be understood that, although engine 1 is shown in FIG. 1 as having four cylinders, any number of cylinders and any cylinder configuration may be employed by engine 1. For example, the system and methods described herein may be applied to V-6, I-4, I-6, V-12, opposed 4, and other engine types.

An air intake 5 is in communication with a low pressure compressor 3a of the low pressure turbocharger stage 3. Further downstream or behind the LP stage 3, a high pressure compressor 4a of the high pressure turbocharger stage 4 is arranged. Parallel to the HP compressor 4a a compressor bypass valve (CBV) 6 is arranged. The valve 6 can be active or passive. Further downstream the HP compressor 4a and the valve 6 an intercooler 7 is arranged in front of the engine 1.

An exhaust system 8 is arranged downstream the engine 1. Directly after the engine 1, a high pressure turbine 4b of the HP stage 4 is provided in parallel with a HP turbine bypass valve (TBV) 9. Further downstream a low pressure turbine 3b of the LP stage 3 is provided in parallel with a LP turbine waste gate (WG) 10.

The engine system comprises the actuators in the air path CBV 6, TBV 9 and WG 10, wherein TBV 9 and WG 10 control the boost pressure once a CBV position (open or closed) is set.

According to a standard control sequence, WG 10 and CBV 6 are closed for low speed or torque while TBV 10 or the HP stage controls the boost pressure. For higher speed or torque the higher pressure forces CBV 6 to open, TBV 9 is fully open and WG 10 or the LP stage controls the boost pressure.

In an alternative control sequence, the optimum WG 10 and TBV 9 are set simultaneously in dependence on the speed or load and the CBV 6 position. This can be called closed loop boost control on TBV 9 or WG 10.

FIG. 2 shows the engine 1 with turbocharger 2 for a setup of a model for determination of P3. P3 or exhaust back pressure is the pressure downstream or behind the engine 1 or between engine 1 and turbocharger 2. T3 is the temperature at this position which is usually measured for an exhaust gas recirculation (EGR) 11. As remarked above, the exhaust manifold pressure parameter is a fundamental property of the engine and helps to determine the exhaust gas recirculation (EGR) flow rate which is important for NOx pollutant reduction, for example. The exhaust back pressure (EBP) is therefore important for a model based air path control and model based charge control (MCC), for example.

At the air intake 5, pressure P1, temperature T1 and mass air flow MAF are present. Pressure P2 and temperature T2 are present in front of the engine 1, i.e., between turbocharger 2 and engine 1. At the exhaust system 8 or at the interface to the exhaust system, pressure P4 and temperature T4 are present. Here, the 1-IP and LP turbines 4a and 3a and the valves 9 and 10 are seen as one unit. P4 and T4 are usually available from exhaust aftertreatment requirements. A waste gate WG 10 feedback measurement may be optionally included in some examples.

Temperature T3 is measured with a sensor 12, pressure P4 and/or temperature T4 with a sensor 13. The sensors 12 and 13 are in communication with a control device 14 which runs a model for determination of P3 which is described in more detail below. The model can first be run in a test environment, for example (S)HIL ((Soft-)Hardware-in-the-loop), and then implemented in a simpler controller or the like. On the other hand it is possible to run the model or certain parts of it on a computer or computational unit of engine control, for example. The control device can be or can be part of a boost controller for controlling the boosting procedures, for example. Further, the control device may include a computer readable storage medium having instructions encoded thereon to execute one or more of the process steps described herein.

FIG. 3 shows a set of diagrams each showing the flow vs. the overall turbine pressure ratio PRT, where PRT is taken across both the HP and LP turbine stages. The data are created from Department of Energy (DOE) calculations with a real-time engine model. Each diagram has a fixed HP turbine bypass valve TBV 9. The diagram in the upper left is taken for a fully closed (FC) TBV while the diagram in the lower right is taken for a fully opened (FO) TBV. The diagrams in between show middle positions of the TBV with the degree of opening in percent. The values in each diagram are taken for different states of the engine with varying waste gate WG 10, engine speed and torque, and updates for lower engine speed, including idle.

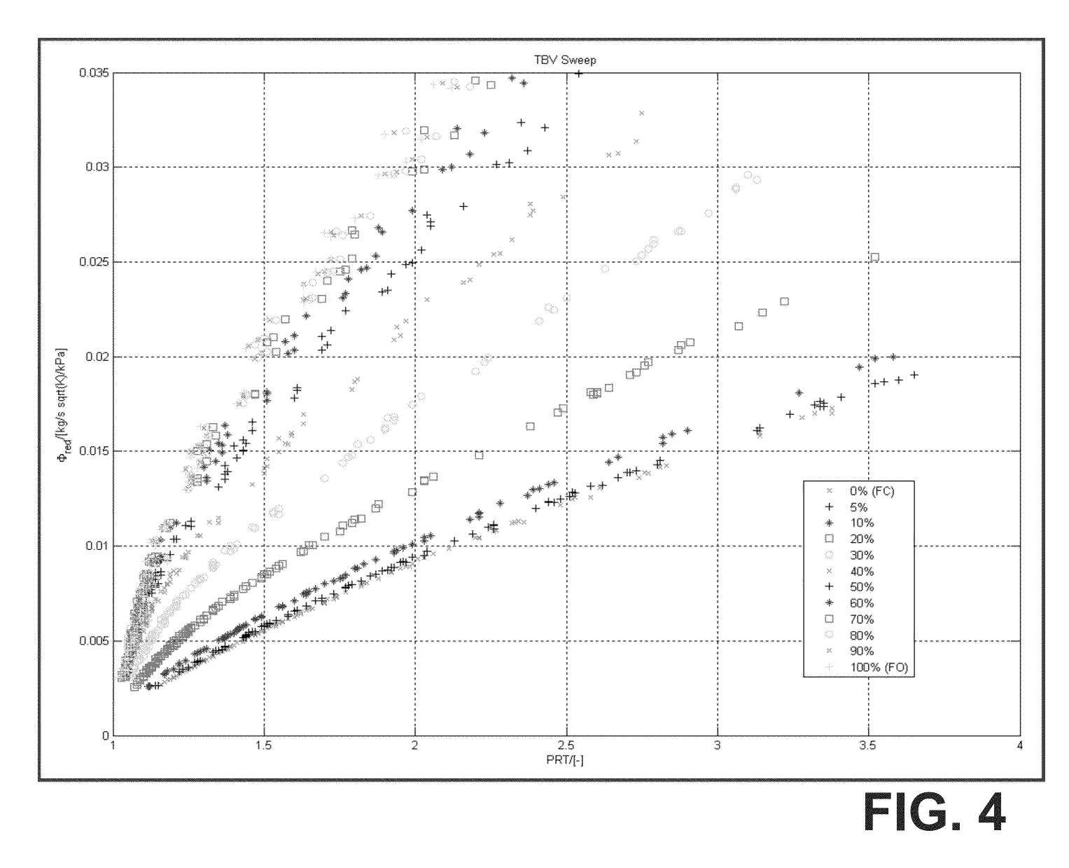

FIG. 4 shows the diagrams of FIG. 3 in combination and shows the overall flow vs. the overall turbine pressure ratio PRT. This curve parameterizes the overall turbine pressure ratio PRT as a function of flow parameter for a fixed TBV position. The waste gate WG 10 is varied and the CBV 6 is passive. For this diagram, the flow parameter is a function of the exhaust flow, T3 and P4. Other parameterisations are possible and further examples are discussed below. More data can be collected in order to improve the fit around PRT=1. In this data, mapping no EGR flow is included; however, in other examples EGR may be included in the parameterization.

Further, in this example, the overall turbine pressure ratio PRT used. However, one can use the overall or total turbine pressure difference across both turbine stages DELTA_P as well. Thus, the ratio PRT, as used herein, may also refer to the difference DELTA_P. The curve for DELTA_P has a similar form to that of the curve for PRT shown in FIG. 4.

The following is a description of an example parameterization of a model for estimating exhaust back pressure in accordance with the disclosure. A measure of the two stage pressure can be given in two forms as discussed above. First, one can use the overall or total (across both turbine stages 4b and 3b) turbine pressure ratio PRT, defined as:

$${\prod }_{R 2 S} = \frac{{P}_{3}}{{P}_{4}}$$

Or one can use the overall or total turbine pressure difference across both turbine stages DELTA_P, defined as:

ΔP_{R2S}=P₃−P₄

The flow parameter may be defined in four forms. A first possibility is the reduced flow (standard), defined as:

$$FLOW 1 = Φ \frac{\sqrt{{T}_{3}}}{{P}_{3}}$$

A second possibility is the corrected flow (standard), defined as:

$$FLOW 2 = Φ \frac{\sqrt{\frac{{T}_{3}}{{T}_{{3}_{REF}}}}}{\frac{{P}_{3}}{{P}_{{3}_{REF}}}}$$

wherein P_{3REF} and T_{3REF} are reference conditions. The third definition is a pseudo reduced flow 1, defined as:

$$FLOW 3 = Φ \frac{\sqrt{{T}_{3}}}{{P}_{4}}$$

And a last possibility is the pseudo reduced flow 2, defined as:

$$FLOW 4 = Φ \frac{\sqrt{{T}_{4}}}{{P}_{4}}$$

The basic structure of the model can be parameterised as a third order curve for a fixed TBV position as:

Π_{R2S} or ΔP_{R2S}=P3_const_CUR(X₂)+X₁*P3_{—}X1_CUR(X₂)+ . . . X₁²*P3_{—}X2_CUR(X₂)+X₁³*P3_{—}X3_CUR(X₂)

wherein:

X₂=TBV

X₁=FLOWₓ

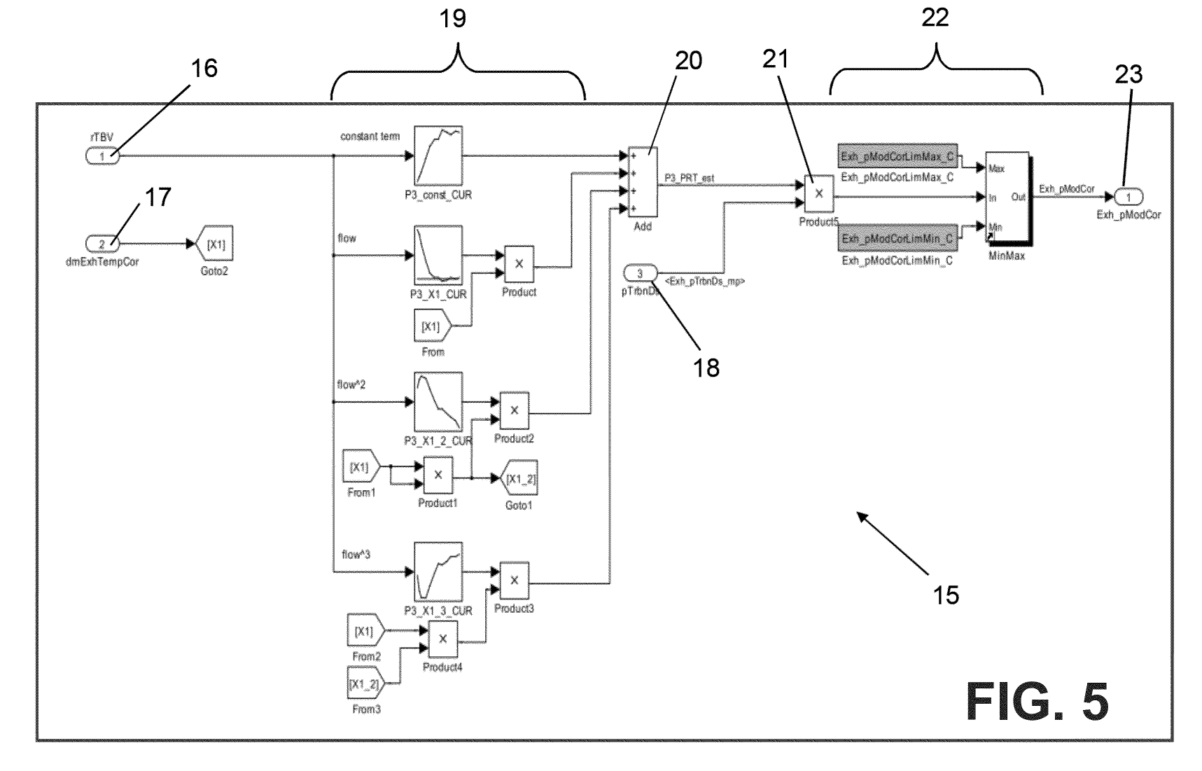

FIG. 5 shows an example implementation of a model 15 for estimating exhaust back pressure in accordance with the disclosure. In this example, inputs of the model are TBV input 16, flow input 17 and P4 input 18. At a calculation stage 19, the single terms of the model curve are calculated which are then added at an addition unit 20 to form a third order curve.

At multiplier 21, the third order curve is multiplied with the pressure P4 in case the overall turbine pressure ratio PRT is utilized. In case of the overall turbine pressure difference DELTA_P or P3-P4, the pressure P4 is added (with an addition unit 21 or with the addition unit 20). The operations may follow these formulas:

P₃=Π_{R2S}*P₄

P₃=ΔP_{R2S}+P₄

This step can be referred to as a signal correction with the pressure P4. The result is a value or signal for the pressure P3 or the exhaust back pressure.

In a further stage 22, the signal for the pressure P3 is clipped or corrected between minimal and maximal limits or boundaries to be output at an output 23.

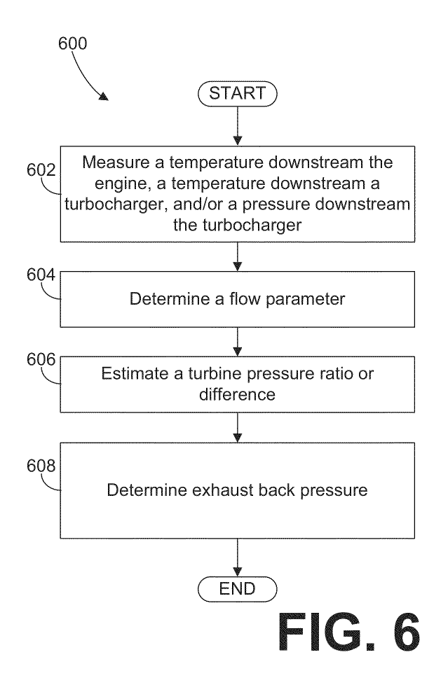

FIG. 6 shows an example method 600 for determining exhaust back pressure (EBP) in accordance with the disclosure. The method acts as an EBP estimator or observer which models the two series turbines and valves as an orifice flow. The exhaust back pressure can be seen as a function of the air volume in the exhaust manifold and flow through the turbine vane restriction. The exhaust flow is an important factor for the base model characterization and can be deducted from the measured parameters. This method of determining the exhaust back pressure (EBP) can be used for a model based charge control (MCC) and/or a model based air path control.

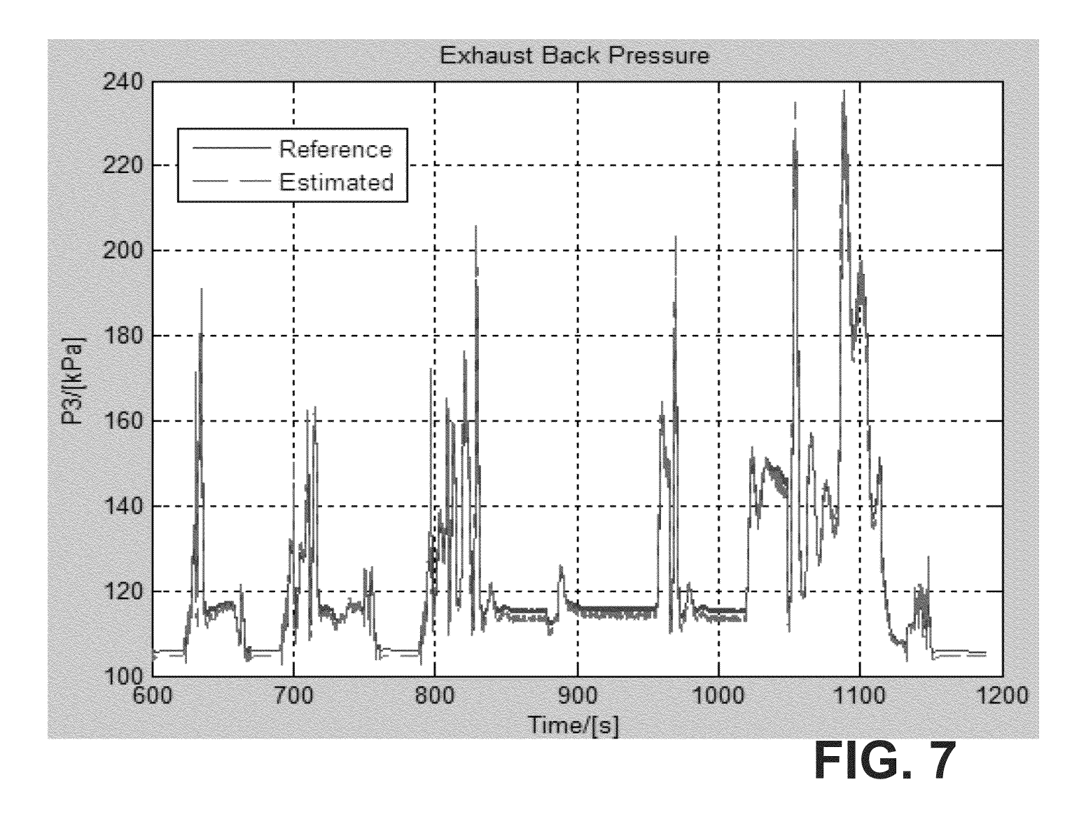

Method 600 may be used in engines with single turbocharger applications as well as engines with a parallel sequential biturbo mode with or without a diesel particle filter (DPF). As illustrated in FIGS. 7-9 described below, the method works fast, reliably and accurately within limits of about +/−5 to +/−20 hPa depending on the state of the engine. The model can be of the kind of mean value engine model (MVEM) so that no pumping fluctuations occur.

At 602, method 600 includes measuring a temperature downstream the engine, a temperature downstream the turbocharger, and/or a pressure downstream the turbocharger. The temperature downstream the turbocharger may be corrected for loss of temperature for a sensor position further upstream. This can remedy the effects of a sensor which is placed too far away from a required location. The correction allows easy adaptation to different hardware environments.

At 604, method 600 includes determining a flow parameter. In some examples, as described above, the flow parameter may have the form of a reduced flow, a corrected flow, or a pseudo corrected flow. Further, in some examples, the flow parameter may be modelled or calculated as a mass air flow plus injected fuel and may be calculated from different temperatures and pressures. The flow can be measured with dynamic estimation, a so called air system model which is easy to model and delivers robust results. For setting up the model the definition of the flow parameter can be chosen according to availability or preciseness of data or sensors.

At 606, method 600 includes estimating a turbine pressure ratio or turbine pressure difference. For example, the turbine pressure ratio or turbine pressure difference may be estimated via a regression model such as a third order curve for a fixed high pressure turbine bypass valve (TBV). The regression model may be a predetermined parameterization of the overall turbine pressure ratio or difference as a function of flow parameter for a fixed turbine bypass valve position. As described below, the exhaust back pressure can be inferred through a regression model of the turbocharger configuration as a variable orifice in the exhaust. The model is set up within certain boundaries or values for the TBV. It can be beneficial to set up a new model for each TBV position or range and to activate or adapt the specific model accordingly. Alternatively, one can integrate the TBV position or range into the model. In some examples, the parameter for the high pressure bypass valve may be a setpoint or may be measured. The model works reliably with both choices. The choice which is easier to implement can be selected.

At 608, method 600 includes determining exhaust back pressure. For example, the exhaust back pressure downstream the engine may be determined based on the estimated overall turbine pressure ratio or a turbine pressure difference and a pressure downstream the engine. In some examples, the exhaust back pressure may be corrected with a pressure downstream the turbocharger. This can be achieved by a multiplication of the pressure (overall turbine pressure ratio) or a subtraction of the pressure (overall turbine pressure difference), for example. Clipping between minimal and maximal boundaries can be used as a further signal correction or as part of the pressure correction. The correction enhances the reliability of the method and eases the transfer and the further processing of the method's results.

FIG. 7 shows a simulation result for an air path. The exhaust back pressure P3 is shown over time. Here, the last 580 seconds of an NEDC (New European Drive Cycle) drive cycle are shown. For the simulation, the model was integrated into a SIL environment and a simplified EGR and boost controller was created. The original data did not include EGR. The actual results depend on hardware configurations like turbocharger maps, valve dimensions and the like. Here, only TBV is actuated over the drive cycle. The diagram shows a measured reference curve and the estimated or calculated curve which is the result of the model. It can be seen that P3 is estimated well over the complete time span.

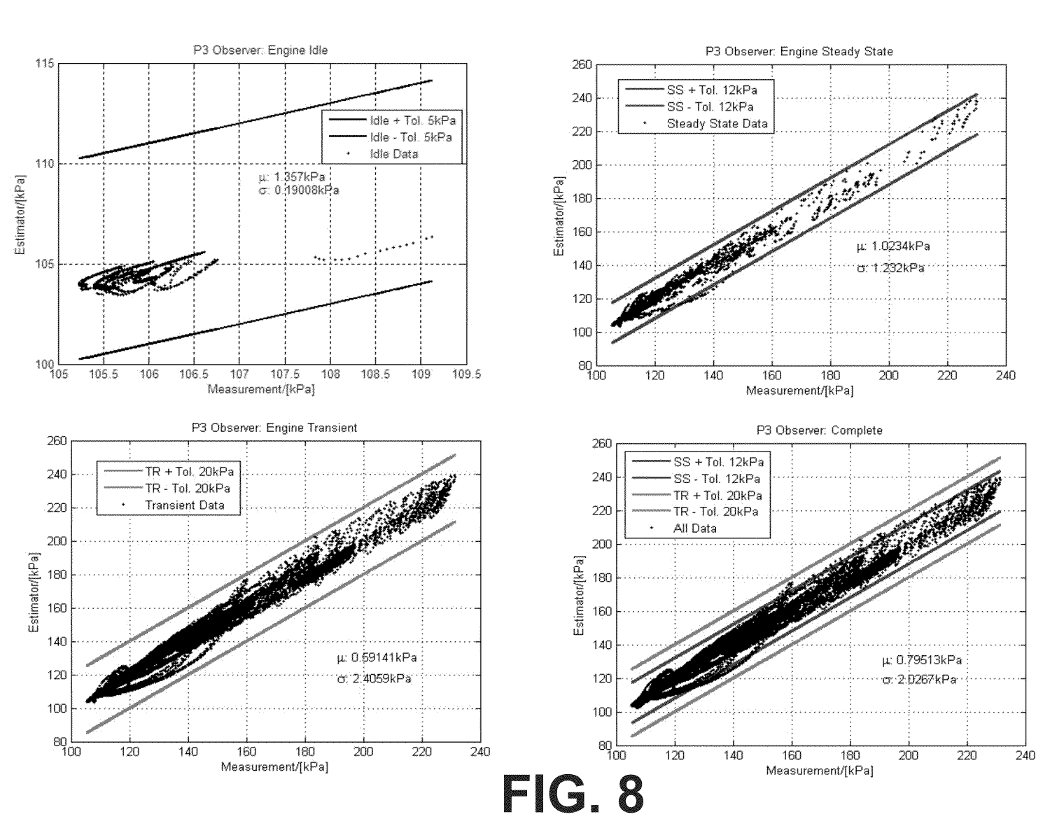

FIG. 8 shows diagrams with the tolerances of the exhaust back pressure results estimated in accordance with the disclosure. In particular, FIG. 8 shows diagrams with P3 results from the NEDC drive cycle with EGR. The estimated or calculated pressure is shown versus the measured pressure for different states of the engine 1. The parallel lines are tolerance boundaries and the curves in between are the estimated values.

The diagram in the upper left shows results for an engine idle state. As can be seen, accuracy lies clearly in the boundaries of +/−5 kPa. The upper right diagram shows results for an engine steady state with an accuracy within +/−12 kPa. The diagram in the lower left shows values for an engine transient state with an accuracy within +/−20 kPa. The diagram in the lower right shows the complete or combined results for all engine states. Most of the results are between the +/−12 kPa tolerances and all of the results lie within the +/−20 kPa tolerances. Therefore, the model works with good accuracy.

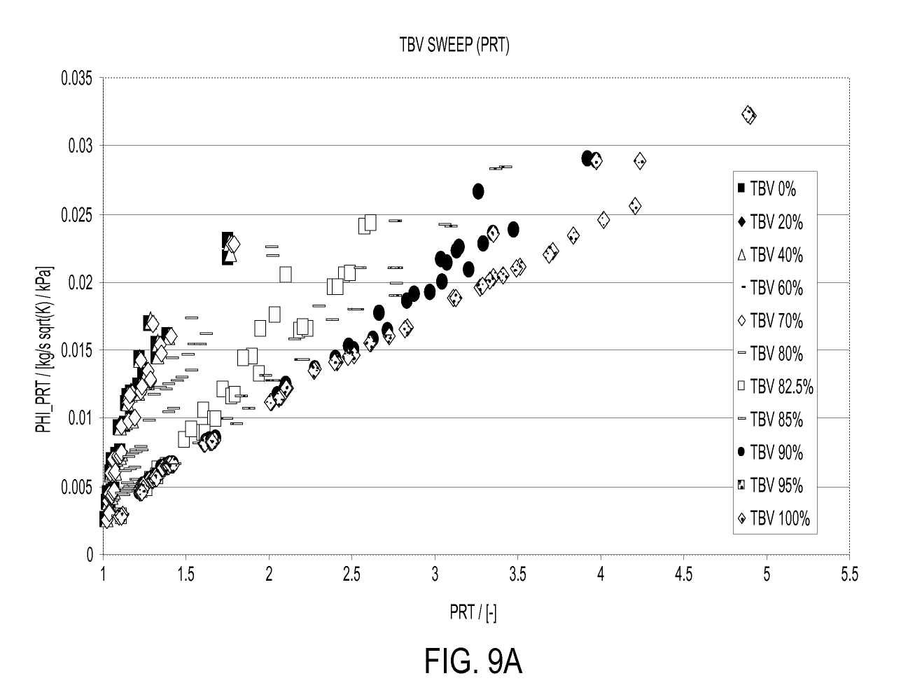

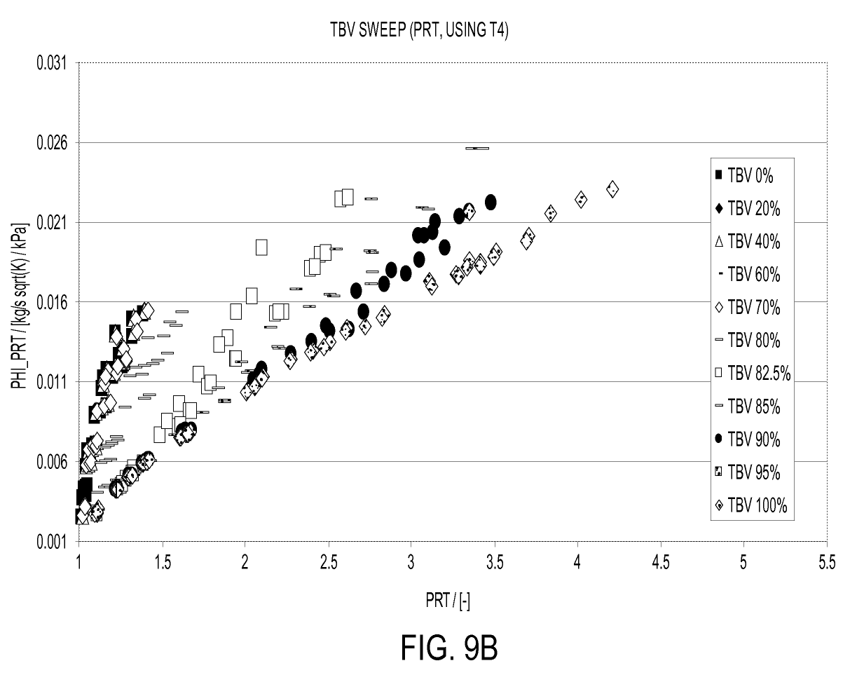

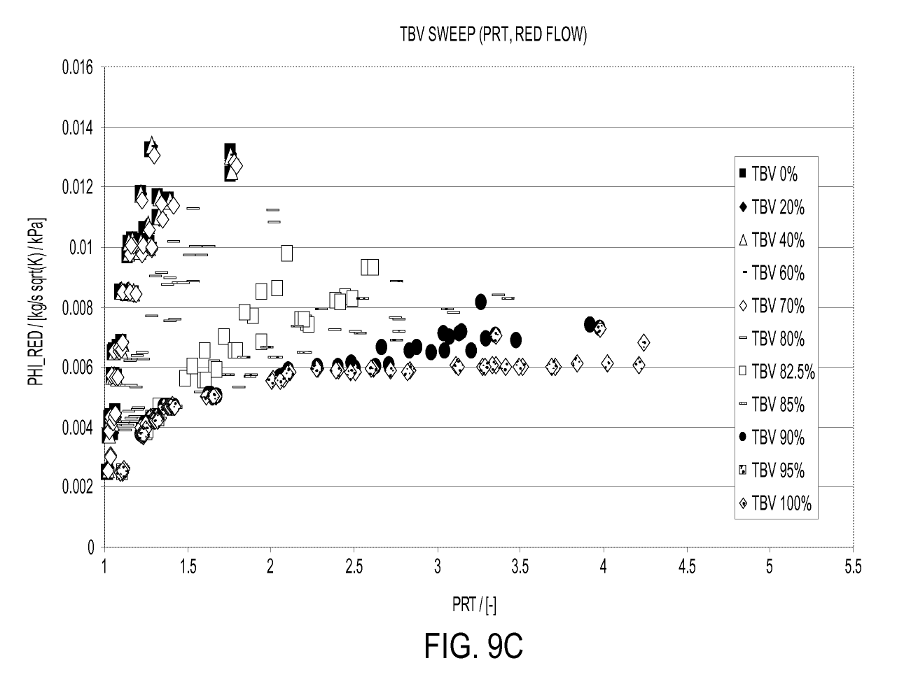

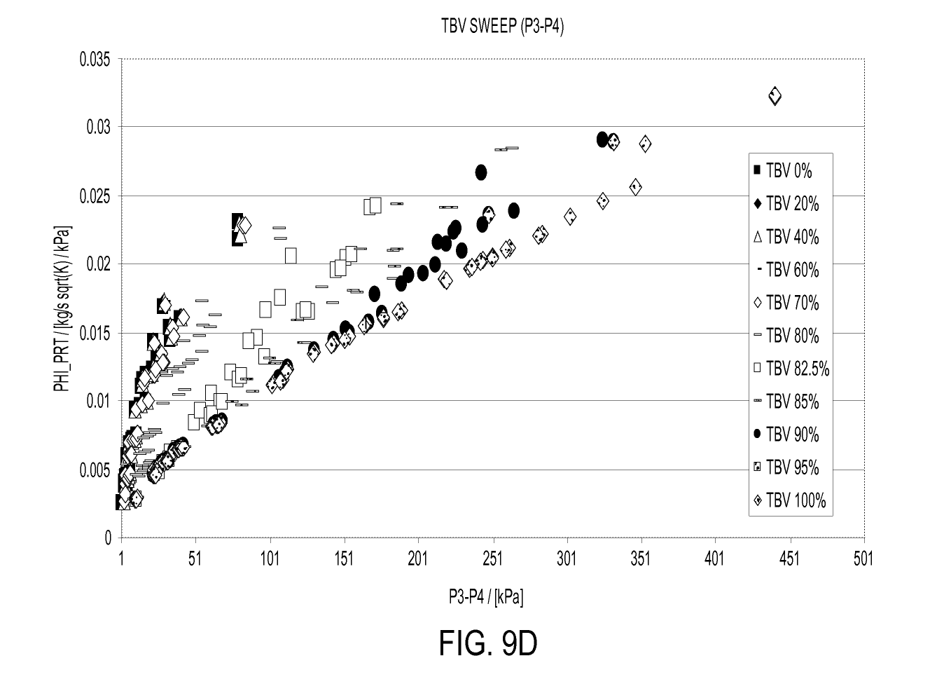

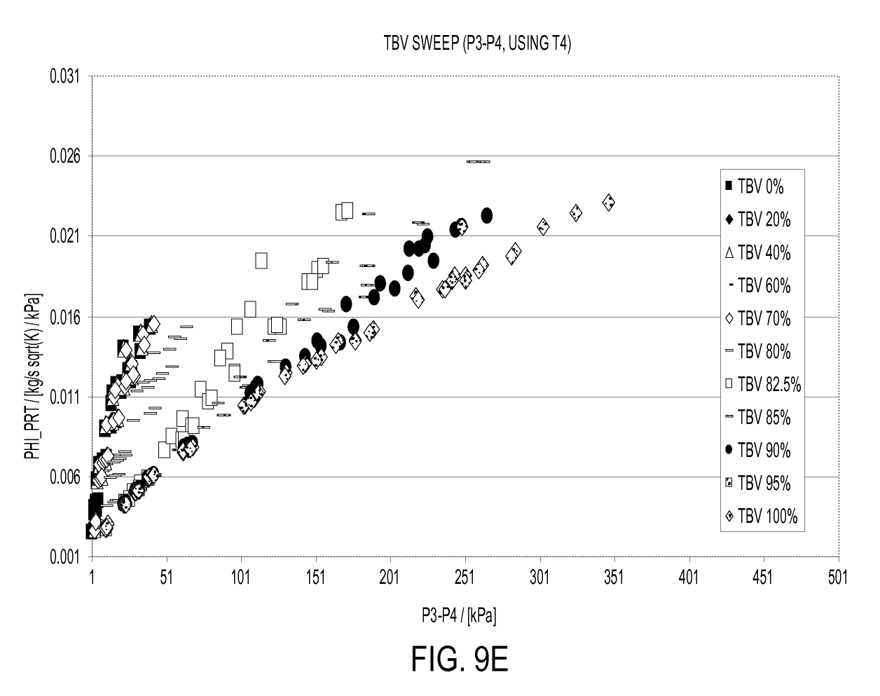

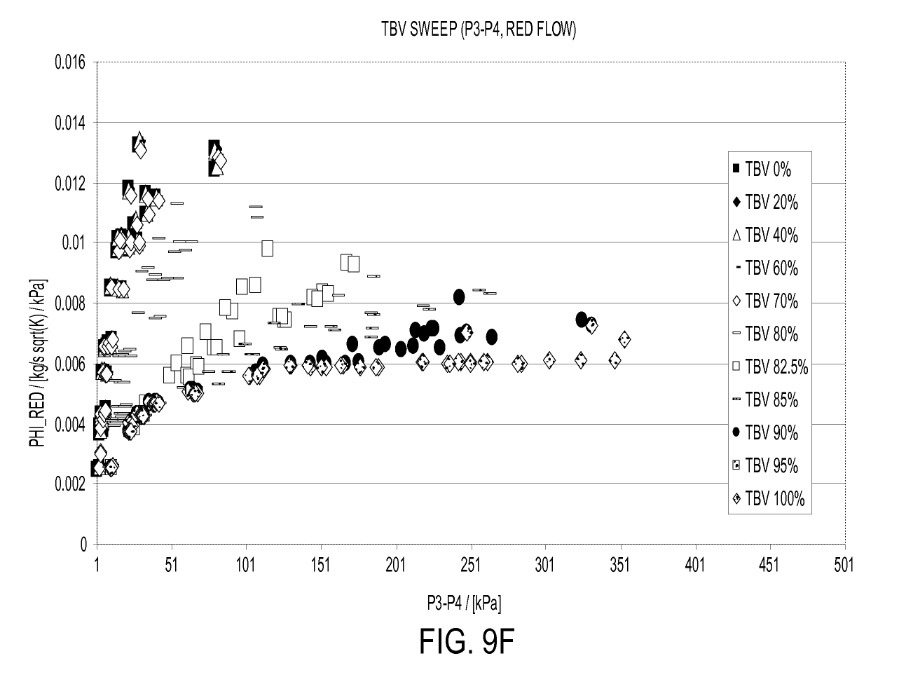

FIG. 9 shows diagrams for different turbine pressure ratios (PRT) and turbine pressure differences (DELTA P) vs. flow parameterisation forms in accordance with the disclosure. These diagrams result from representative series sequential hardware on a two litre EURO VI diesel engine. An optimised calibration for engine torque with given turbine shaft speed (TSS) and pre turbine, post compressor temperature was chosen. The data include different WG openings, from fully closed to fully open, and the data are plotted for fixed TBV positions.

The upper diagrams show the flow PHI vs. the pressure ratio PRT while the lower diagrams show the flow PHI vs. the pressure difference P3-P4. The two left diagrams show data for a TBV sweep while the two middle diagrams show data for a TBV sweep with the use of the temperature T4. The two diagrams to the right show data for a reduced flow. The first two columns are very similar since the only difference is a scaling by a square root of T3 or T4. However, the third column with reduced flow has noticeably less dispersion, with a flatter response at larger PRT's or DELTA P's. The case of corrected flow is not shown as this is only a constant scaling for the reduced flow case. All curves have a continuous profile which shows the quality of the model.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for an engine with a turbocharger, comprising:
measuring a temperature downstream the engine, a temperature downstream the turbocharger, and/or a pressure downstream the turbocharger;
determining a flow parameter for exhaust mass flow;
estimating an overall turbine pressure ratio or a difference with a model of the turbocharger based on the measured and determined parameters;
determining the exhaust back pressure downstream the engine with the model.

2. The method of claim 1, wherein the turbocharger is a two-staged turbocharger.

3. The method of claim 1, further comprising correcting the overall turbine pressure ratio or the difference with the pressure downstream the turbocharger.

4. The method of claim 1, wherein the overall turbine pressure ratio or the difference is estimated via a regression model based on a high pressure turbine bypass valve position.

5. The method of claim 4, wherein the regression model is a predetermined parameterization of overall turbine pressure ratio or difference as a function of flow parameter for a fixed turbine bypass valve position.

6. The method of claim 4, wherein the regression model is a third order curve for a fixed high pressure turbine bypass valve.

7. The method of claim 4, wherein the high pressure turbine bypass valve position is a setpoint or is measured.

8. The method of claim 1, wherein the flow parameter has the form of a reduced flow, a corrected flow, or a pseudo reduced flow.

9. The method of claim 1, wherein the flow parameter is modelled or calculated as mass airflow plus injected fuel.

10. The method of claim 1, wherein the temperature downstream the turbocharger is corrected for loss of temperature for a sensor position further downstream.

11. A system for an engine with a turbocharger, comprising:
at least one of a temperature sensor downstream the engine, a temperature sensor downstream the turbocharger, and pressure sensor downstream the turbocharger; and
a computer readable storage medium having instructions encoded thereon, including:
instructions to measure a temperature downstream the engine, a temperature downstream the turbocharger, and/or a pressure downstream the turbocharger;
instructions to determine a flow parameter for exhaust mass flow;
instructions to estimate an overall turbine pressure ratio or a difference with a model of the turbocharger based on the measured and determined parameters; and
instructions to determine the exhaust back pressure downstream the engine with the model.

12. The system of claim 11, wherein the turbocharger is a two-staged turbocharger.

13. The system of claim 11, wherein the computer readable storage medium further includes instructions to correct the overall turbine pressure ratio or the difference with the pressure downstream the turbocharger.

14. The system of claim 11, wherein the computer readable storage medium further includes instructions to correct the temperature downstream the turbocharger for loss of temperature for a sensor position further downstream.

15. The system of claim 11, wherein the overall turbine pressure ratio or the difference is estimated via a regression model based on a high pressure turbine bypass valve position and wherein the high pressure turbine bypass valve position is a setpoint or is measured.

16. The system of claim 11, wherein the flow parameter has the form of a reduced flow, a corrected flow, or a pseudo reduced flow and is modelled or calculated as mass airflow plus injected fuel.

17. A method for an engine with a turbocharger, comprising:
adjusting an operating parameter responsive to exhaust back pressure, the backpressure based on an estimated overall turbine pressure ratio which is based on a temperature downstream the engine, and a pressure downstream the engine.

18. The method of claim 17, wherein the overall turbine pressure ratio is estimated via a regression model based on a predetermined parameterization of overall turbine pressure ratio or difference as a function of a flow parameter for a fixed turbine bypass valve position.

19. The method of claim 18, wherein the flow parameter has the form of a reduced flow, a corrected flow, or a pseudo reduced flow and is based on a mass airflow plus injected fuel.
